(19) United States
(12) Patent Application Publication
(10) Pub. No.: US 2004/0018866 A1
(43) Pub. Date: Jan. 29, 2004

(54) Symbol display device for game machine

(75) Inventor: Haruo Inoue, Tokyo (JP)

Correspondence Address: YOUNG & THOMPSON, 745 SOUTH 23RD STREET 2ND FLOOR, ARLINGTON, VA, 22202

(73) Assignee: DRAGON CO., LTD., Tokyo (JP)

(21) Appl. No.: 10/300,740

(22) Filed: Nov. 21, 2002

(30) Foreign Application Priority Data
Jul. 26, 2002 (JP) 2002-218434

(51) Int. Cl. A63F 9/24; A63F 13/00; G06F 17/00; G06F 19/00

(52) U.S. Cl. 463/16

(57) ABSTRACT

A symbol display device includes a first rotary disk with a small diameter and a second rotary disk with a large diameter, which rotate independently while overlapping with each other. A driving shaft, which is firmly fixed to the center of the first rotary disk, is penetrating a hole formed at the center of the second rotary disk. A plate-shaped flange is fixed to the second rotary disk so as to fill in the hole. A driving pipe is firmly fixed to the flange, and the driving shaft is rotatably inserted in the driving pipe. A first stepping motor is connected to the rear end of the driving shaft protruding from the driving pipe, to which a large pulley is firmly fixed. A small pulley is fixed to the driving shaft of a second stepping motor. Rotation of the second stepping motor is transmitted to the second rotary disk through a timing belt.

### BACKGROUND OF THE INVENTION

1. Field of the Invention

The present invention relates to a rotary disk-type symbol display device for a game machine.

2. Description Related to the Prior Art

For a slot game, there are a mechanical-type symbol display device for rotating plural reels having symbols on the periphery thereof and a video-type symbol display device that displays the rotation of the reels imitatively on a CRT, a liquid crystal display (LCD) and the like. The symbol display device for a roulette game has a rotary disk with the content of the roulette game provided by characters and images. The rotary disk is rotated upon starting the game and is stopped at a predetermined timing. In this kind of rotary disk symbol display device, the win or the loss of the game is determined on the basis of a symbol, which is the character, the image and so forth on the rotary disk and is pointed by an index disposed at a predetermined position. Note that such rotary disk symbol display devices are built not only in a roulette game machine but in a slot machine for determining odds of dividend coins in sub-game, for example. Thereby, a slot machine with a varied way of play may be provided.

Some rotary disk symbol display devices have two coaxial rotary disks having different sizes of external diameters, and rotate them (disclosed in Japanese Patent Laid-Open Publication Number H7-323110, for example.) A large rotary disk unit and a small rotary disk unit are provided in this symbol display device, and a driving motor and a support frame for supporting the driving motor are unified with each of the rotary disks in the respective rotary disk units. The rotary disk is composed of a hub firmly fixed to a driving shaft of the motor, spokes extended from the hub, and a rotary disk part, which is fixed on the spokes and on which symbols are displayed. With such composition, weight of the large and the small rotary disk units including plural rotary disks may be dispersed not to center on a single support frame and, at the same time, each unit may be easily assembled.

However, in order to build such a symbol display device having plural rotary disk units in the slot machine, the symbol display device needs to be compact as the space for installing the symbol display device is small. As for the above-described symbol display device, the driving motor for driving the small rotary disk and another driving motor for driving the large rotary disk are fixed to the front of the small rotary disk and to the rear side of the large rotary disk respectively. The back part of the small rotary disk unit enters a concave part formed at the front side of the large rotary disk unit. Therefore, a space for building the driving motor for rotating the small rotary disk is required, so that the depth of the symbol display device becomes long. Also, since the small rotary disk unit and the large rotary disk unit are built in the game machine separately, it is difficult to position the small rotary disk unit and the large rotary disk unit, even the units may be easily built in the game machine. Consequently, the workability deteriorates.

### SUMMARY OF THE INVENTION

An object of the present invention is to provide a symbol display device that may be easily built in a game machine.

Another object of the present invention is to provide a compact symbol display device.

A further object of the present invention is to provide a symbol display device wherein positions of two rotary disks, which rotate coaxially, may be easily adjusted.

In order to achieve the above-described objects and other objects, the symbol display device of the present invention includes “N” rotary disks that rotate independently from each other, a driving shaft for driving the first rotary disk, disposed at the outermost position among said “N” rotary disks so as to be the nearest from the player than the other rotary disks, and (N-1) driving pipes having different diameters for driving from the second to the “N”th rotary disks. The (N-1) driving pipes are set so that the driving pipe having the longest diameter is set at the outermost position and that the driving pipe having the shortest diameter is set at the innermost position. The driving shaft is inserted in the driving pipe having the shortest diameter. Openings are provided at the centers of from the second rotary disk to the “N”th rotary disk so as to drive the rotary disks disposed at each of their outsides.

In one of preferable embodiments of the present invention, each rotary disk has different diameters, and the first rotary disk has the shortest diameter and the “N”th rotary disk has the longest diameter. The front side of the first rotary disk is exposed and parts of from the second to the “N”th rotary disks are exposed in ring-shapes. The exposed parts carry symbols.

Each driving pipe is driven by each stepping motor via each reduction mechanism. As the reduction mechanism, for example, a belt transmitting mechanism, composed of a large pulley, a small pulley and a timing belt, is used. The small pulley and the large pulley are fixed to the stepping motor and the rear end of the driving pipe respectively. The driving pipes having smaller diameters are formed to be longer so that the rear ends of each driving pipe are exposed in order of size. The first rotary disk is rotated by the driving shaft, which is rotatably set in the smallest driving pipe. The driving pipe may be used as the driving shaft.

According to the present invention, a driving mechanism of the rotary disk may be simplified and a position of each rotary disk may be easily adjusted, since the driving pipes are used as the rotary shafts for driving each rotary disk and the driving pipes are disposed concentrically. In addition, the rotary disks may rotate smoothly even when rotating slowly, as the rotation of the stepping motors are transmitted to the rotary disks via the reduction mechanism. Furthermore, as being unitized, the symbol display device of the present invention may be easily built in the game machine.

### BRIEF DISCRIPTION OF THE DRAWINGS

One with ordinary skill in the art would easily understand the above-described objects and advantages of the present invention when the following detailed description is read with reference to the drawings attached hereto.

FIG. 1 is a perspective view of a slot machine, according to the present invention;

FIG. 2 is an exploded perspective view of a composition of a symbol display device in the present invention;

FIG. 3 is an exploded perspective view of a composition of flanges for rotary disks and rotary shafts;

FIG. 4 is a perspective view of a disassembled composition in the neighborhood of bearing members and bearing brackets;

FIG. 5 is a perspective view of a disassembled composition in the neighborhood of a stepping motor for rotating a second rotary shaft;

FIG. 6 is a perspective view of a disassembled composition in the neighborhood of a stepping motor for rotating a first rotary shaft;

FIG. 7 is a cross-sectional view of a symbol display device;

FIG. 8 is a perspective view of an appearance of a roulette game machine with the symbol display device of the present invention;

FIG. 9 is a perspective view of a disassembled composition in the neighborhood of the rotary shafts if there are first-third rotary disks;

FIG. 10 is a cross-sectional view of an embodiment wherein the first rotary shaft is rotated by a pulley;

FIG. 11 is a cross-sectional view of an embodiment wherein a gear is formed at the periphery of the second rotary disk;

FIG. 12 is a cross-sectional view of an embodiment of the symbol display device wherein the first rotary disk is provided with windows so that the symbols on the second rotary disk may be observed through the windows;

FIG. 13 is a plane view of the symbol display device shown in FIG. 12; and

FIG. 14 is an embodiment of the symbol display device wherein the first rotary disk is made of transparent material.

### PREFERRED EMBODIMENTS OF THE INVENTION

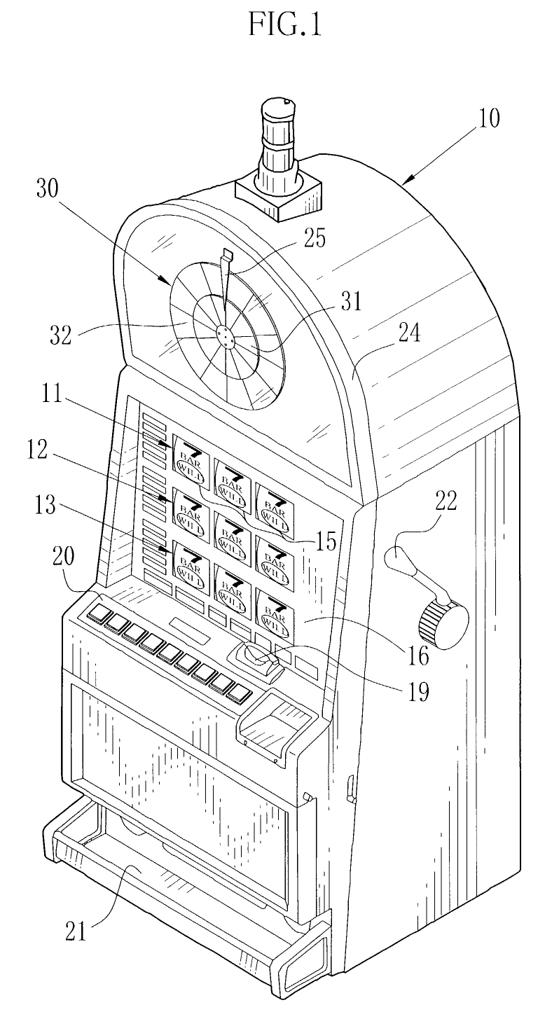

As shown in FIG. 1, a first reel unit 11, a second reel unit 12 and a third reel unit 13 are provided in a slot machine 10 for executing slot game. Three mechanical reels line up sideways in each reel unit 11-13, which means that there are nine mechanical reels altogether with 3 rows and 3 lines. A front panel 16, in which display windows 15 are formed by a number of the reels, is provided in front of each reel unit 11-13. Thereby, three symbols of the respective reels appear through the display windows in a vertical direction.

A coin slot 19, an operation panel 20 and a coin tray 21 are provided below the front panel 16 and, above it, a symbol display device 30 of the present invention, built as a dividend determining device, is provided. A start lever 22 is provided at a side of the slot machine 10. Note that the front side of the symbol display device 30 is covered with a glass door 24.

In this slot machine 10, whether win or lose the game is determined by each of the first-third reel units 11-13 respectively. A predetermined number of winning lines are provided in each reel unit in advance, and the winning lines are validated at each reel unit in accordance with bet number. As the start lever 22 is operated, the game is started and a player wins if a predetermined combination of the symbols appears on the validated winning lines or if predetermined symbols are stopped on the winning lines. There are ranking in the winning, and dividend coins are dispensed in the coin tray 21 in accordance with the winning rank. In addition, for example, if a combination of the symbols that composes a big trigger appears on the validated winning line, the symbol display device 30 is operated. Note that, though here it is omitted to describe about the types, numbers, disposing order of the symbols and the number of winning lines, they may be determined appropriately in the light of contents of the game. Conditions for operating the symbol display device 30 may be determined appropriately as well.

The symbol display device 30 determines the number of free games performed without inserting a coin, and odds of dividend coins in a case the player wins the free game. In the symbol display device 30, first of all, a first display 31 is rotated and then stopped after a predetermined time. Next, a second display 32 is rotated and then stopped after a predetermined time. The numbers on the first display 31 and the second display 32, pointed by an index 25, represent the number of free games to be executed and odds of dividend coins to provide if the player wins the free game.

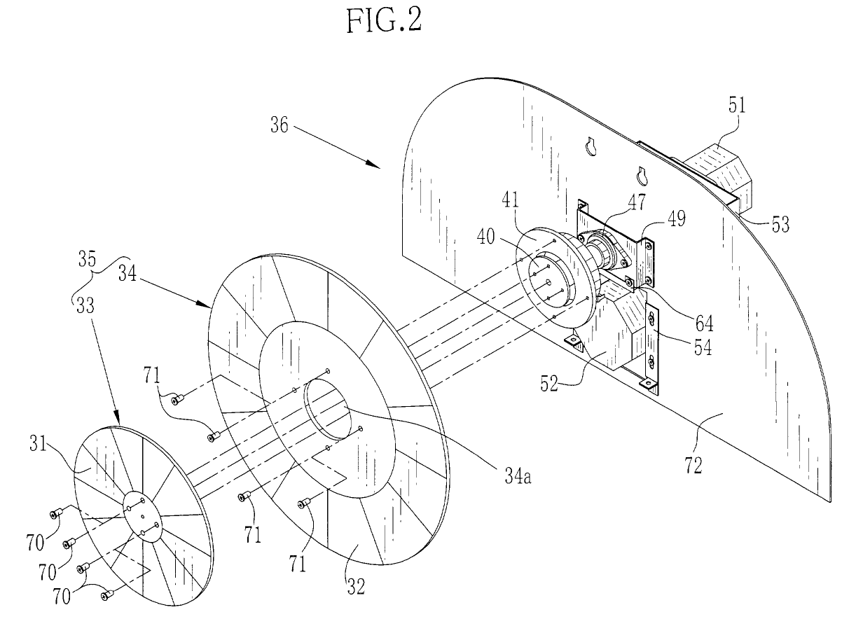

As shown in FIG. 2, the symbol display device 30, used as the dividend determining device, is a unit composed of a display part 35, which consists of a first rotary disk 33 whereon a first display 31 is formed and a second rotary disk 34 whereon on a second display 32 is formed, and a driving part 36 for driving each of the first rotary disk 33 and the second rotary disk 34. Note that the symbol display device 30 is built in the slot machine 10 through a unit support plate 72.

The first display 31 formed on the first rotary disk 33 is sectioned into plural sector areas, and in each of them, are drawn symbols (1, 5, 7, 10, and 20, for example) representing the number of the free games. The second rotary disk 34 is formed to have a larger external diameter than that of the first rotary disk 33, and has an opening 34a at the center thereof where a flange 42 for the first disk, described later, is inserted in. Note that the second display 32 formed on the second rotary disk 34 is formed so as not to overlap with the first display 31. The second display 32 is sectioned into plural sector areas, and in each of them, are drawn symbols ( X1, X3, X5, X7, for example) representing the odds of the dividend coins to provide if the player wins the free game. Note that images drawn to represent the number of the free games or the odds of the dividend coins may be appropriate objects such as marks, codes, numbers, patterns, characters and the like.

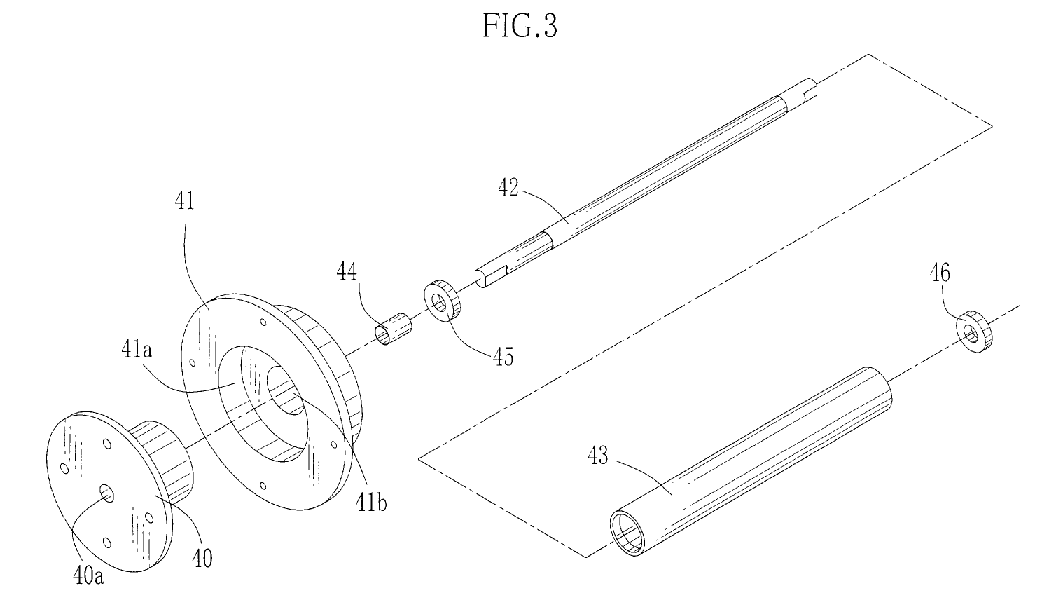

As shown in FIG. 3-FIG. 7, the driving part 36 is composed of a small size flange 40, a large size flange 41, a first rotary shaft 42, a second rotary shaft 43, a collar 44, bearings 45 and 46, bearing members 47 and 48, bearing brackets 49 and 50, stepping motors 51 and 52, motor mounting brackets 53 and 54, pulleys 55 and 56, a timing belt 57, a coupling 58, a first signal segment 59, a second signal segment 60, a first display rotation detecting sensor 61, a second display rotation detecting sensor 62, and retaining members 63 and 64.

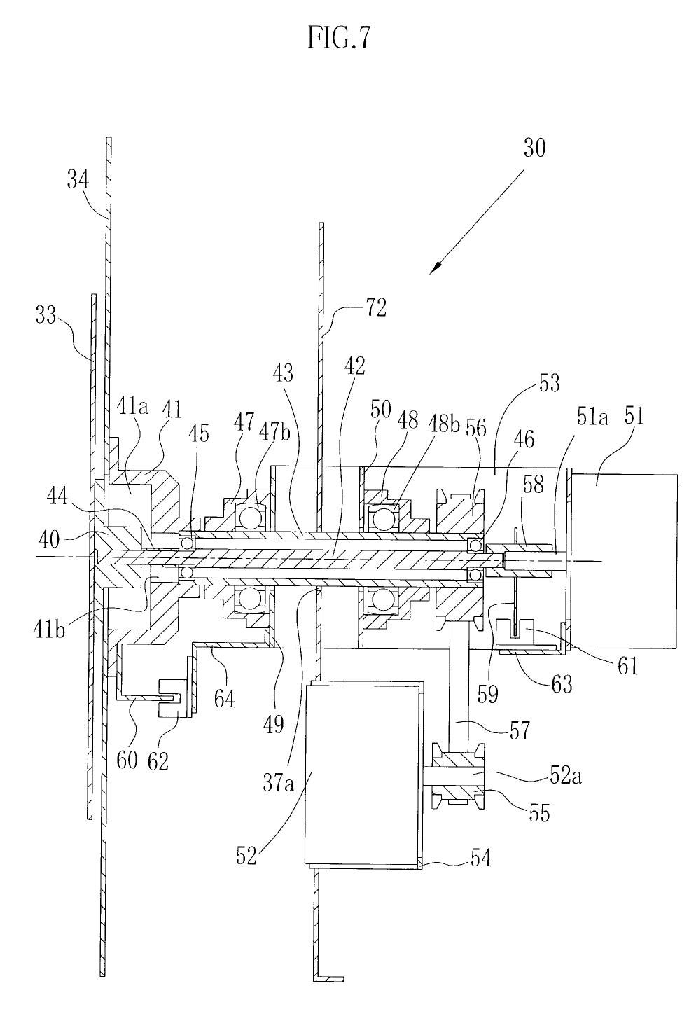

As shown in FIG. 2 and FIG. 3, the small size flange 40 is fixed to the rear side of the first rotary disk 33 with screws 70. An opening 40a is formed on the small size flange 40, and one end of the first rotary shaft 42, through which the bearings 45 and the collar 44 are inserted, is firmly fixed to the opening 40a. The large size flange 41 is fixed to the rear side of the second rotary disk 34 with screws 71. A concave part 41a is formed on the large size flange 41, to contain the small size flange 40. On the large size flange 41, an opening 41b is formed, where one end of the second rotary shaft 43 is firmly fixed to (see FIG. 7). The second rotary shaft 43 forms a tubular shape and the first rotary shaft 42 is inserted therein.

The second signal segment 60 is firmly fixed to the large size flange 41, and its rotation is observed by the second display rotation detecting sensor 62. That is, on every turn of the second rotary disk 34, the second display rotation detecting sensor 62a outputs reset signals. The second display rotation-detecting sensor 62 is fixed to the retaining member 64, which is firmly fixed to the bearing bracket 49. Note that the reference numeral 78 represents a screw to fix the retaining member 64.

The first rotary shaft 42 is provided for rotating the first rotary disk 33. After being inserted into the second 5 rotary shaft 43, one end of the first rotary shaft 42 (the end which is fixed to the small size flange 40) is inserted into the bearing 45 and then into the collar 44, and the other end of the first rotary shaft 42 is inserted into the bearing 46.

The second rotary shaft 43 is a driving pipe, and the 10 bearings 45 and 46, which are bearing members for the first rotary shaft 42, are fixed to shaft holes at both ends of the second rotary shaft 43. The large size flange 41, as described above, and the pulley 56 are fixed to one end of the second rotary shaft 43 and the other end thereof respectively. Note that the first driving shaft 42 may be a driving pipe for the purpose of reducing its weight.

The bearings 45 and 46 function as bearing members for the first rotary shaft 42 and, at the same time, support the first rotary shaft 42 so that the first rotary shaft 42 and the 20 second rotary shaft 43 are concentrically rotated. The collar 44 is held by rear side of the small size flange 40 and the bearing 45 (see FIG. 7). Thereby, the collar 44 determines a position for the small size flange 40.

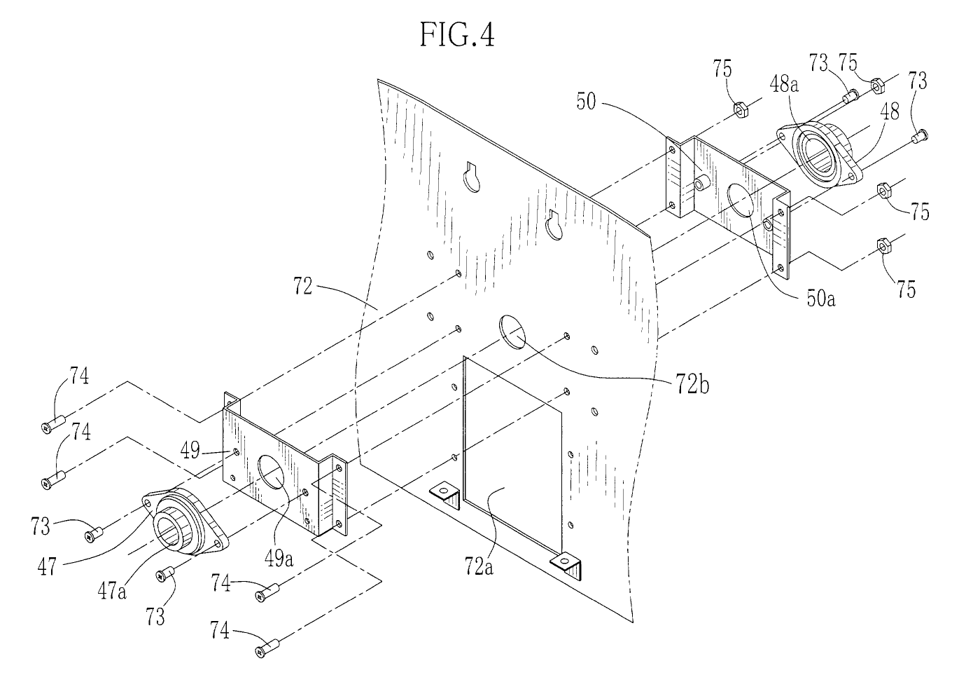

As shown in FIG. 4, the bearing members 47 and 48 have openings 47a and 48a, where the second rotary shaft 43 is inserted into, and bearings 47b and 48b are provided in the bearing members 47 and 48 so as to hold the second rotary shaft 43 rotatably. The bearing members 47 and 48 are fixed to the bearing brackets 49 and 50 with screws 73 respectively. Openings 49a and 50a are formed in the bearing brackets 49 and 50 respectively, in which the second rotary shaft 43 is inserted. Note that the bearing brackets 49 and 50 are fixed to both sides of the unit support plate 72 together with screws 74 and nuts 75, after the bearing members 47 and 48 are attached to the bearing brackets 49 and 50.

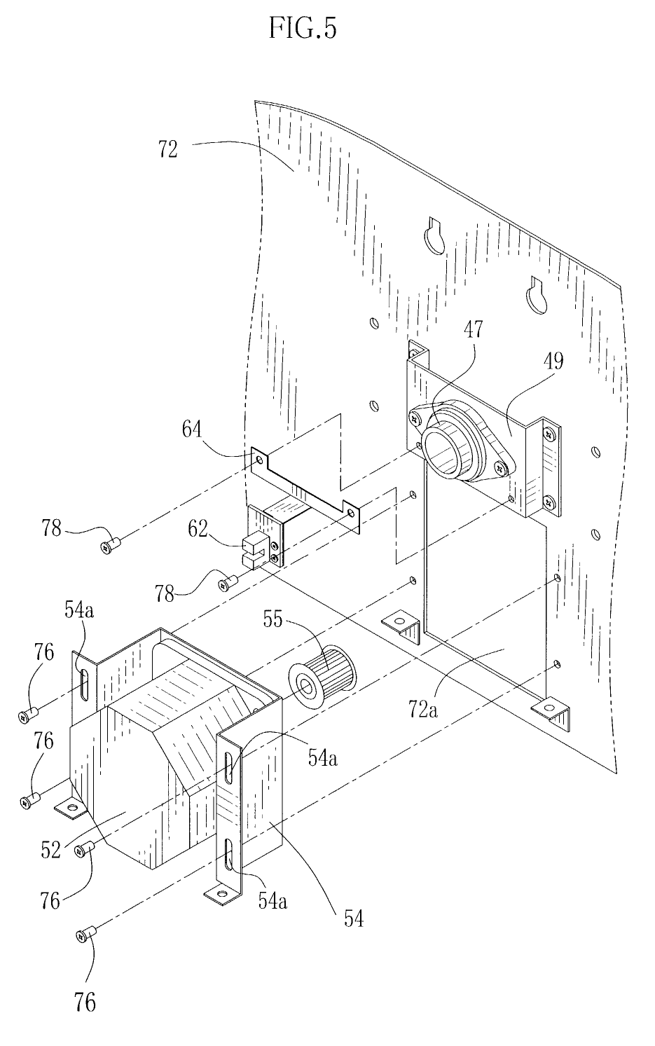

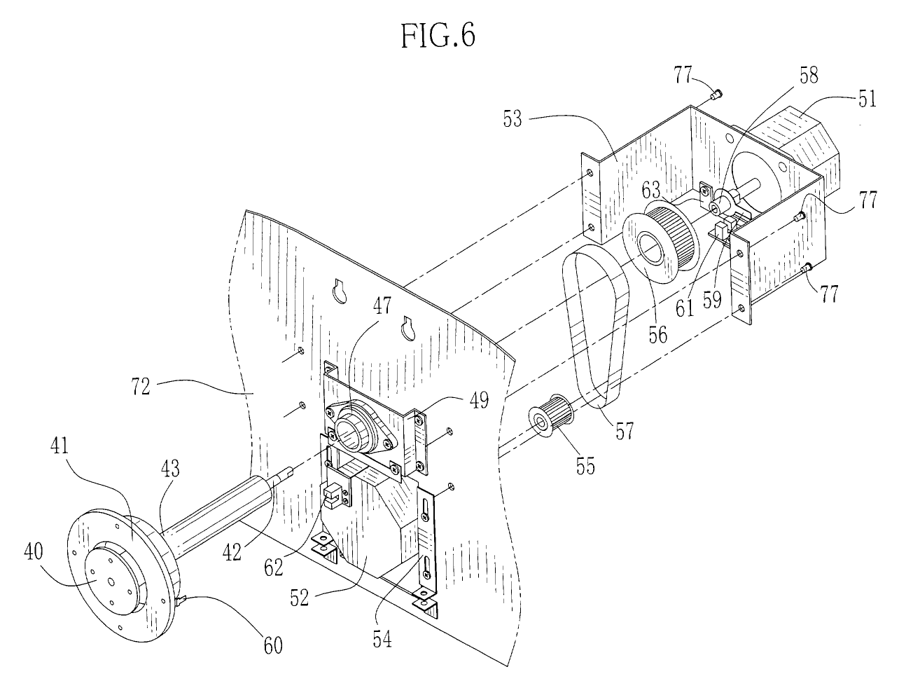

As shown in FIG. 5 and FIG. 6, the stepping motors 51 and 52 are fixed to the brackets 53 and 54 respectively. The brackets 53 and 54 are fixed to the unit support plate 72 with screws 76 and 77 respectively. The bracket 54 is fixed to the unit support plate 72 in a state that the bracket 54 is inserted in an opening 72a of the unit support plate 72. In addition, elliptic holes 54a are provided in the bracket 54 for adjusting the tension of the timing belt 57, which is described later. The coupling 58 and the pulley 55 are fixed to the driving shaft 51a of the stepping motor 51 and the driving shaft 52a of the stepping motor 52 respectively. Note that the reference numeral 72b represents an opening where the second rotary shaft 43 is inserted in.

The coupling 58 forms a tubular shape, and connects the first rotary shaft 42 and the driving shaft 51a of the stepping motor 51 (see FIG. 7). Thereby, the first rotary disk 33 rotates by the stepping motor 51.

The first signal segment 59 is fixed to the coupling 58 for indicating a reference position, and its rotation is observed by the first display rotation-detecting sensor 61. On every turn of the first rotary disk 33, the first display rotation detecting sensor 61 outputs a reset signal. Note that the first display rotation-detecting sensor 61 is fixed to the retaining member 63, which is fixed to the bracket 53.

The timing belt 57 wraps around the pulley 56, fixed to the second rotary shaft 43, and the pulley 55 fixed to the driving shaft 52a of the steeping motor 52. Thereby, driving force from the stepping motor 52 is transmitted to the pulley 56 through the timing belt 57. The external diameter of the pulley 55 is formed to be smaller than that of the pulley 56. Consequently, the rotation of the second rotary disk 34 becomes smaller than the unit step angle of the stepping motor 52, and that enables the second rotary disk 34 to rotate smoothly even when rotating slowly.

In order to assemble the rotary disk-shaped symbol display device 30 described above, first of all, the driving shaft 51a, which the coupling 58 is fixed to, of the stepping motor 51 is fixed to the bracket 53. The driving shaft 52a, which the pulley 55 is fixed to, of the stepping motor 52 is fixed to the bracket 54. The retaining member 63, to which the first display rotation-detecting sensor 61 is fixedly attached, is fixed to the bracket 53. As shown in FIG. 4 and FIG. 5, the bearing brackets 49 and 50, to which the bearing members 47 and 48 are fixed with screws 73, are fixed to the unit support plate 72 together with screws 74 and nuts 75. Then, the retaining member 64, to which the second signal segment 62 is attached, is fixed to the bracket 49 with screws 78. Also, the bracket 54, to which the stepping motor 52 is fixed, is temporarily fixed to a predetermined position with screws 76.

The large size flange 41 is fixed to one end of the second rotary shaft 43, in which the first shaft 42 is inserted. The first rotary shaft 42 in inserted in the bearings 45 and 46, and then fixed in the second rotary shaft 43. Thereby, the first rotary shaft 42 and the second rotary shaft 43 are supported concentrically.

After the first rotary shaft 42 is inserted in the collar 44, the small size flange 40 is fixed. As shown in FIG. 6, the second rotary shaft 43 is inserted in the bearing members 47 and 48, which are firmly fixed to the unit support plate 72. The pulley 56 is fixed to the other side of the second rotary shaft 43, and the pulleys 56 and 55 are wrapped with the timing belt 57. Since the bracket 54 is merely fixed temporarily, the bracket 54 may be adjusted to be fixed at the position the timing belt 57 is tensed.

The bracket 53 is fixed to the unit support plate 72 after one end of the first rotary shaft 42 is fixed to the other end of the coupling 58. As shown in FIG. 2, the rotary disk-shaped symbol display device 30 is completed when the second rotary disk 34 and the first rotary disk 33 are fixed to the large size flange 41 and the small size flange 40 respectively in the last place. Note that the symbol display device may be compactified, as the stepping motors 51 and 52 for rotating the first rotary disk 33 and the second rotary disk 34 may be disposed at the rear sides of the first rotary disk 33 and the second rotary disk 34 respectively. In addition, since each member is fixed to the unit support plate 72, the workability is improved.

As the dividend determining device, the rotary disk-shaped symbol display device assembled as shown above is installed at the upper position of the slot machine 10, having apparatuses such as the first-third reel units 11-13 and a coin dispenser. The process of installing the symbol display device 30 may be simplified, as it only requires the slot support plate 72 to be built in the predetermined position of the slot machine 10. In addition, since the position for building the symbol display device 30 is only inside the slot machine 10, the shape of the glass door 24 may be designed freely.

As the start lever 22 is pulled after as many coins as the player want to bet are dropped in, the first-third reel units 11-13 are operated and the nine reels 15 are rotated. If the winning symbol combinations appear on the validated winning lines in each reel unit 11-13, that means the player wins the game, and dividend coins are given to the player in accordance with the rank of the winning symbol combinations.

If the player wins in a particular way while playing the slot game described above, the first rotary disk 33 and the second rotary disk 34 are rotated at the predetermined timings independently. Since the pulleys 55 and 56 are provided to reduce the rotational speed of the second rotary disk 34 slower than that of the stepping motor 52, the step angle of the rotation of the second rotary disk 34 is reduced to rotate smoothly. The number of the free games and odds of dividend coins are determined by the numbers indicated on the first display 31 and on the second display 32 respectively when the rotation of the first display 31 and the second display 32 are stopped. Next, a free game is started as the start lever 22 is operated without feeding coins, as many times as the number of times determined by the first display 31. On each free game, the amount of dividend coins to be provided is dividend coins, determined in normal free game, multiplied by the odds determined by the second display 32.

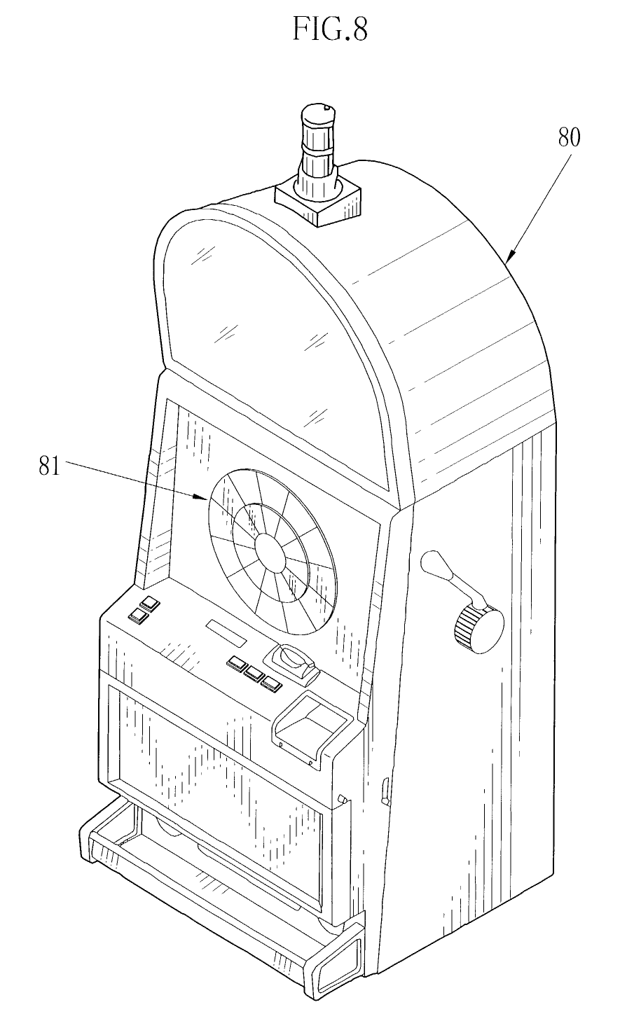

Other than being built in the slot machine as the dividend determining device, the rotary disk-shaped symbol display device 30 may also be built in as a symbol display device 81 for a roulette game machine 80, as shown in FIG. 8. The symbol display device of the present invention may be used appropriately in the light of contents of the game, apart from being used as the free game determining device of the slot machine.

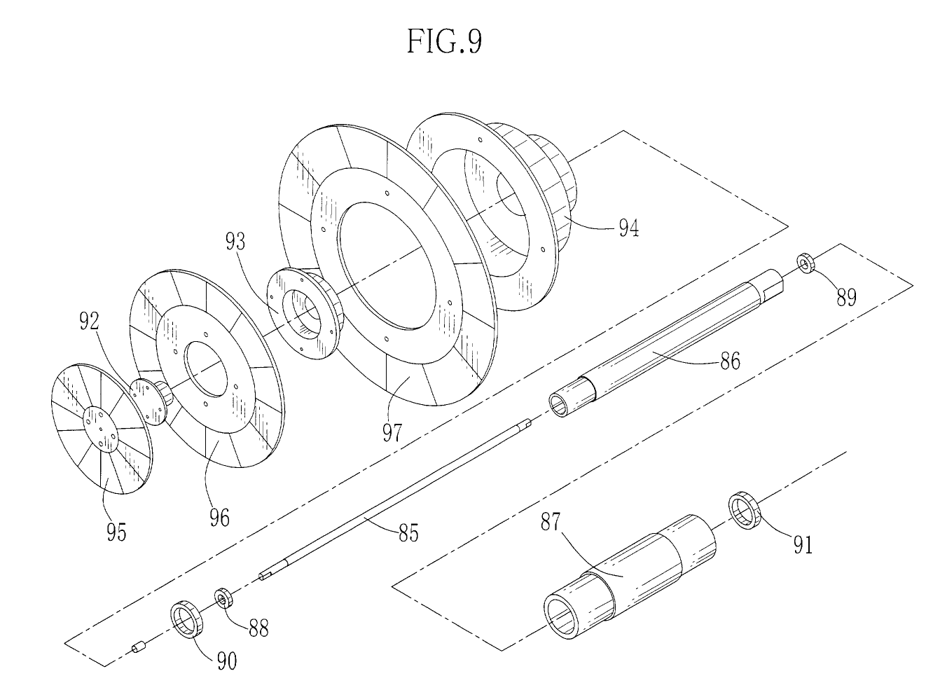

The present invention may be used as the symbol display device composed of first-third rotary disks. In this case, first-third rotary shafts 85-87 are provided, and the second rotary shaft 86 and the third rotary shaft 87 are formed tubular shapes, as shown in FIG. 9. Then, the first rotary shaft 85 is held to be concentric with the second rotary shaft 86, by inserting the first rotary shaft 85 in the second rotary shaft 86 and fixing bearings 88 and 89 to both ends of the second rotary shaft 86. Similarly, the second rotary shaft 86 is supported to be concentric with the third rotary shaft 87, by fixing bearings 90 and 91 to both ends of the third rotary shaft 87 after the second rotary shaft 86 is inserted in the third rotary shaft 87. Consequently, the first-third rotary shafts 85-87 become concentric. Then, each of first-third rotary disks 95-97 may be rotated concentrically and independently, by fixing the first-third rotary disks 95-97 after fixing first-third rotary disk flanges 92-94 to one end of each of the first-third rotary shafts 85-87 respectively.

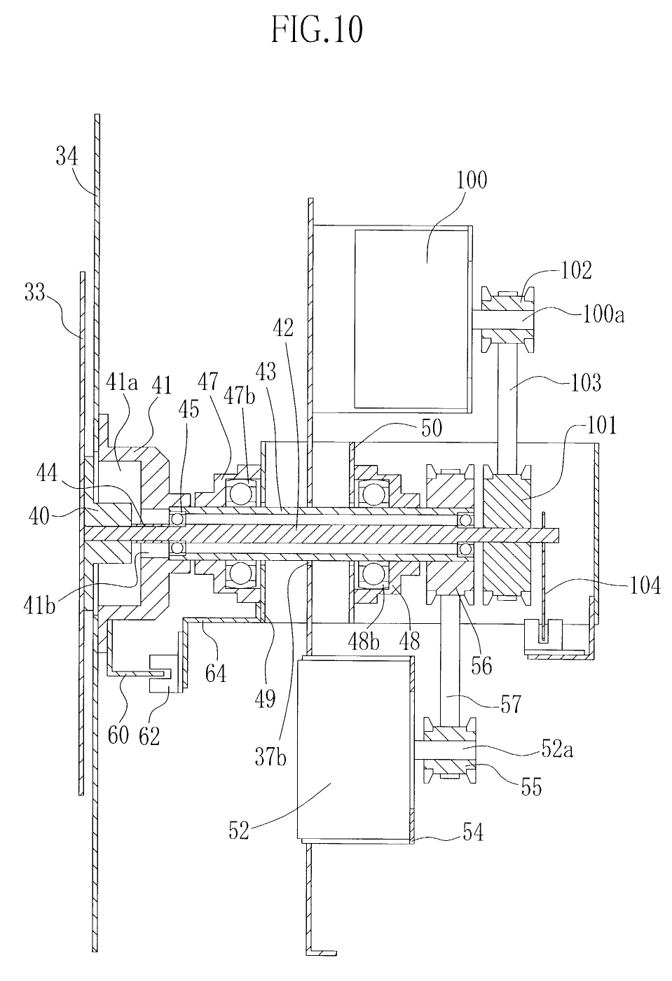

In the above embodiment, the stepping motor 51 for rotating the first rotary disk 33 and the first rotary shaft 42 are disposed to be concentric, and the first rotary shaft 42 and the driving shaft 51a for the stepping motor 51 are connected by the coupling 58. In the embodiment shown in FIG. 10, the first rotary shaft 42 is rotated by belt drive, and the same numerals as in FIG. 7 are used for the same parts. A driven pulley 101 and a driving pulley 102 are fixed to one end of the first rotary shaft 42 and a driving shaft 100a for a stepping motor 100 respectively, and driving force of the stepping motor 100 is transmitted to the first rotary shaft 42 through a timing belt 103. A first signal segment 104 is fixed to the first rotary shaft 42. In this case, not only the second rotary disk 34 but also the first rotary disk 33 may rotate smoothly, since the external diameter of the driven pulley 101 is formed to be larger than that of the driving pulley 102 so that the rotational speed of the first rotary disk 33 is reduced to be slower than that of the stepping motor 100. In addition, the depth of the symbol display device may be shortened to be downsized.

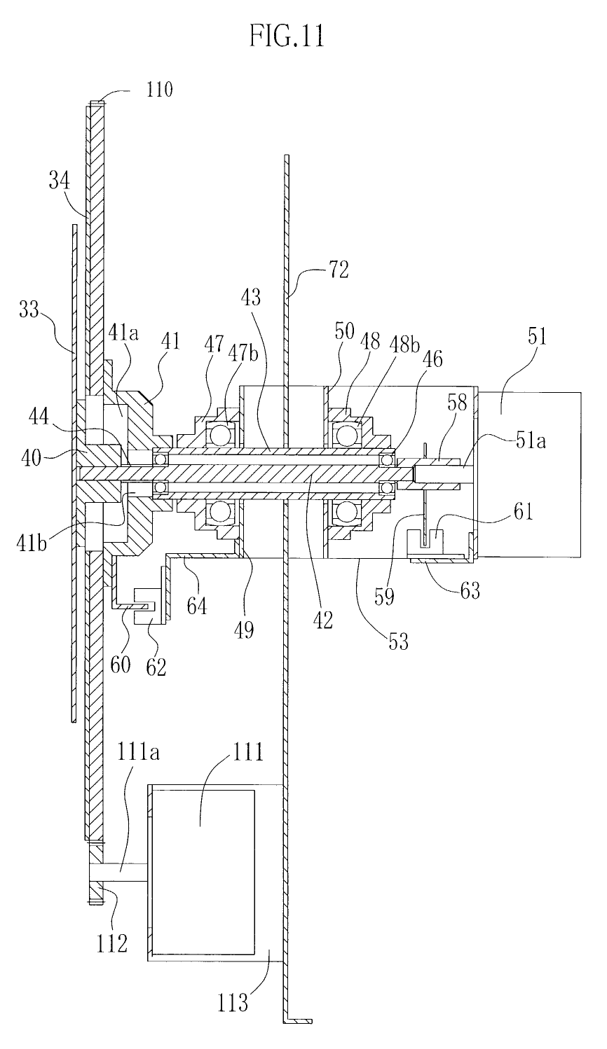

An embodiment wherein the second rotary disk 34 is driven by a gear mechanism is shown in FIG. 11. A gear 110 is formed at the periphery of the second rotary disk 34, and a gear 112 is provided on a driving shaft 111a for a stepping motor 111. The stepping motor 111 is fixed to the unit support plate 72 through a bracket 113 so that the gears 110 and 112 gear with each other. In this case, driving force of the stepping motor 111 is transmitted without the second rotary shaft 43. Note that the second rotary shaft 43 functions as a retention member to hold the second rotary disk 34 and the first rotary disk 33 concentrically.

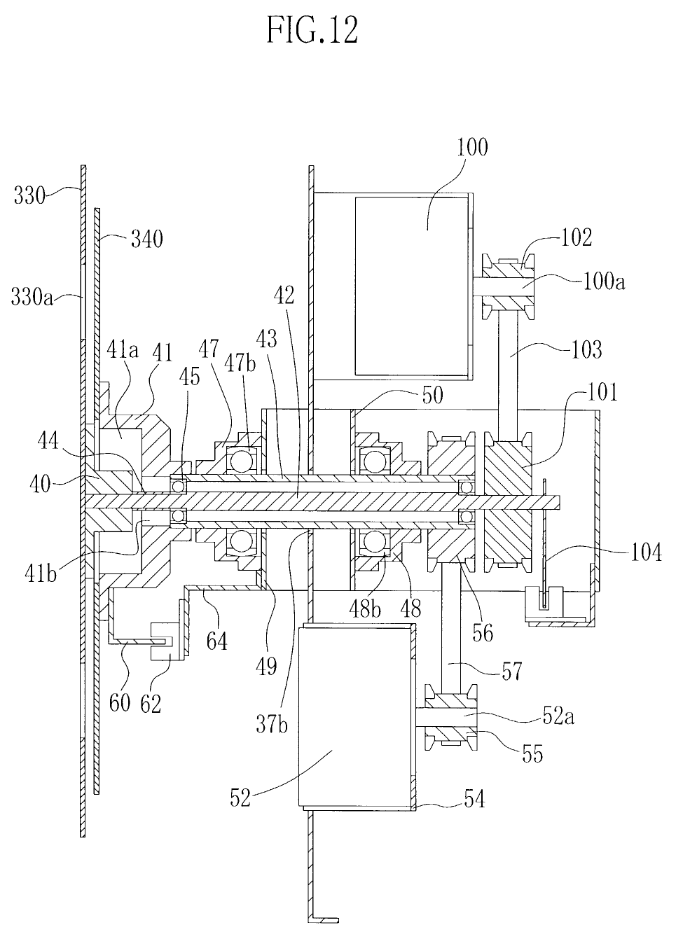

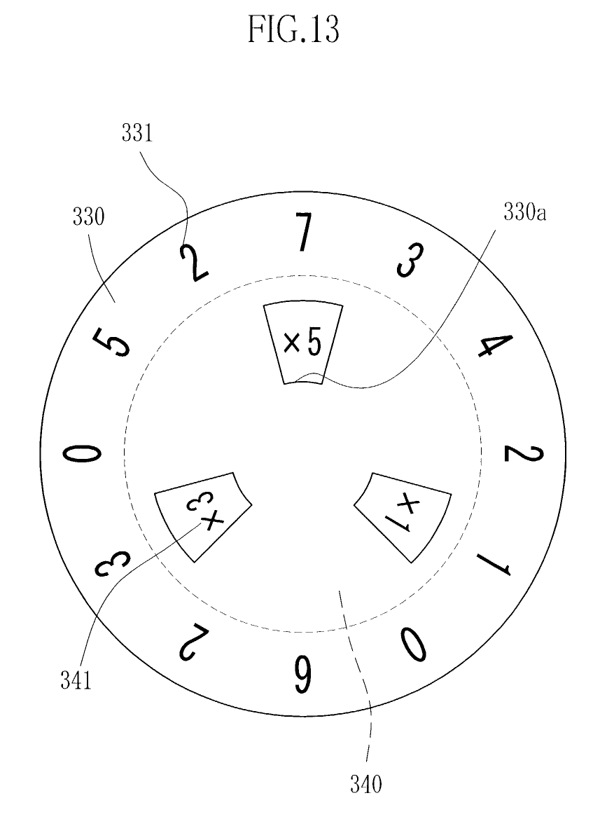

FIG. 12 and FIG. 13 show an embodiment wherein the first rotary disk is provided with windows so that the symbols on the second rotary disk may be observed through the windows. Plural numbers 331 are printed on the periphery of the first rotary disk 330 to show the number of times of the free game. Windows 330a are provided in the first rotary disk 330 at regular intervals. The second rotary disk 340 is formed to have a smaller diameter than that of the first rotary disk 330. Numbers 341 are printed on the second rotary disk 351 for representing the odds of dividend coins to be provided to the player in the free game. The numbers 341 may be observed through the windows 330a.

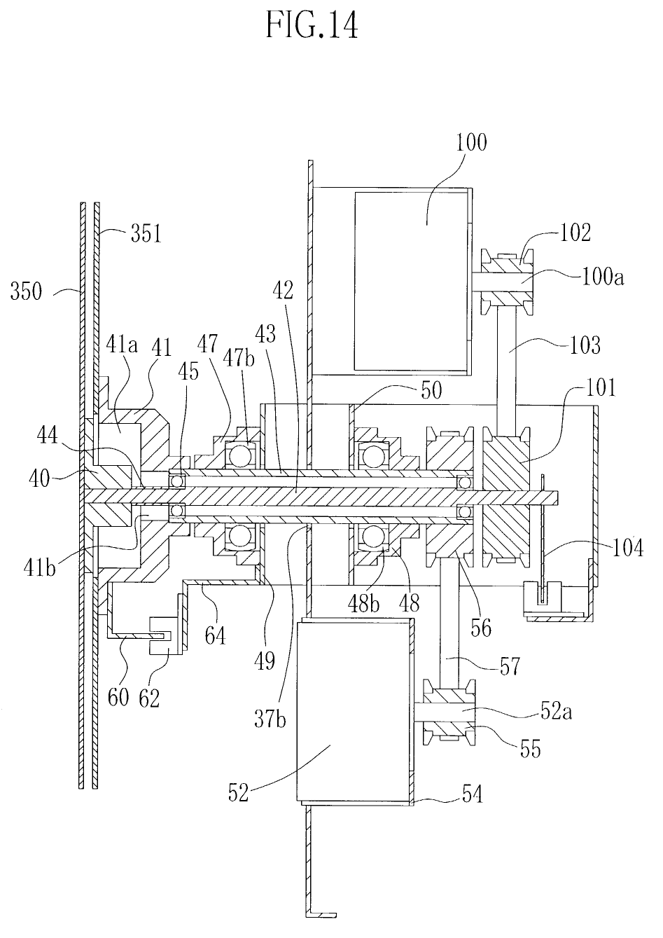

FIG. 14 shows an embodiment wherein the first rotary disk is made of transparent material. The first rotary disk 350 is formed of transparent plastic, and plural numbers, representing the number of times of the free game, are printed on its periphery. The numbers representing the odds of dividend coins are printed on the inner side of the second rotary disk 351. The numbers of the odds on the second rotary disk 351 may be observed at inner side of the numbers of times of the free game printed on the first rotary disk 350, and may be observed through the first rotary disk 350.

Various changes and modifications are possible in the present invention and may be understood to be within the present invention.

What is claimed is:

1. A symbol display device for a game machine comprising:
“N” (“N” is an integer of 2 or more) rotary disks disposed with overlapping with each other;
symbols carried on each of said rotary disks;
a driving shaft for driving the first rotary disk disposed at the outermost position among said “N” rotary disks so as to be the nearest from the player than the other rotary disks;
(N-1) driving pipes for rotating the respective rotary disks arranged from the second to the “N”th among said “N” rotary disks, said driving pipe for driving said second rotary disk has the shortest diameter, said driving pipe for driving said “N”th rotary disk has the longest diameter, said driving pipes are set so that said driving pipe for said “N”th rotary disk is set outermost and that said driving pipe for said second rotary disk is set innermost, said driving shaft is inserted in said driving pipe for said second rotary disk; and
openings provided at the centers of said rotary disks from second to “N”th for transmitting driving force from said driving pipes and said driving shaft to said rotary disks disposed at each of their outsides, said opening in said second rotary disk has the shortest diameter, said opening in said “N”th rotary disk has the longest diameter.

2. A symbol display device described in claim 1, wherein said driving shaft has the longest length to protrude from said smallest driving pipe, the smallest driving pipe is the longest and the largest driving pipe is the shortest among said (N-1) pipes.

3. A symbol display device described in claim 2, further including “N” stepping motors, said stepping motors driving said driving shaft and driving pipes individually.

4. A symbol display device described in claim 3, wherein said “N” is “2”, said driving shaft is rotatably inserted in the sole driving pipe.

5. A symbol display device described in claim 4, further including plural reduction mechanism provided between said stepping motor and driving pipe, said reduction mechanism smoothing rotation of said rotary disk.

6. A symbol display device described in claim 5, wherein each of said rotary shafts from second to “N” has plate-shaped flanges, to which each of said driving pipes are connected.

7. A symbol display device described in claim 6, wherein said driving pipes except the outermost driving pipe are rotatably supported through bearings by said driving pipes set outside of each driving pipe, said bearings are fixed to holes of said driving pipes set outside of each driving pipe.

8. A symbol display device described in claim 7, wherein said reduction mechanism includes a small pulley fixed to said stepping motor, a large pulley fixed to the rear end of said driving pipe, and a timing belt wrapping around said small pulley and said large pulley.

9. A symbol display device described in claim 7, wherein said reduction mechanism is provided with driving gears fixed to said stepping motors and other gears formed at peripheries of said rotary disks and having more gears than said driving gears.

10. A symbol display device described in claim 1, wherein said symbol display device is unitized.

11. A symbol display device for a game machine comprising:
“N” (“N” is an integer of 2 or more) rotary disks having different sizes, said rotary disks overlapping with each other in order of size so that (N-1) rotary disks except the first rotary disk having the smallest size are exposed in ring-shapes;
symbols formed on the exposed surfaces of each of said rotary disks;
openings provided at the centers of said rotary disks from second to “N”th, sizes of said openings corresponding to the sizes of said rotary disks;
a driving shaft for rotating said first rotary disk, and (N-1) driving pipes with different sizes, the smallest driving pipe among them transmits the rotation to said second rotary disk, the largest driving pipe transmits rotation to said “N”th rotary disk, said driving shaft is rotatably inserted in said smallest driving pipe, each driving pipe is set in each other so that said largest driving pipe is set at outermost position and said smallest driving pipe at innermost position.
